(19) United States
(12) Patent Application Publication
(10) Pub. No.: US 2011/0152452 A1
(43) Pub. Date: Jun. 23, 2011

(54) EMULSION POLYMERIZATION PROCESS, POLYMER DISPERSION AND FILM-FORMING COMPOSITION

(75) Inventors: Dirk Emiel Paula Mestach, BNijlen (BE); Richard Hendrikus Gerrit Brinkhuis, Zwolle (NL); Andrea Henricus Johannes Roelofs, Arnhem (NL); Hendrik Hermanus Rikus Van Der Horst, Oss (NL)

(73) Assignee: Nuplex Resins BV, Bergen OP Zoom (NL)

(21) Appl. No.: 12/901,620

(22) Filed: Oct. 11, 2010

Related U.S. Application Data
(63) Continuation of application No. 10/555,829, filed on May 10, 2006, now abandoned.

(30) Foreign Application Priority Data
May 6, 2003 (EP) 03076396.5

(51) Int. Cl. C08F 2/22; C08F 2/38

(52) U.S. Cl. 524/832

(57) ABSTRACT

The present invention relates to a method to prepare a polymer dispersion using an aqueous substantially surfactant-free emulsion polymerization process comprising a seed and a feed stage, in which seed stage at least one ethylenically unsaturated monomer, having a water-solubility of at least 0.3 g/l at polymerization conditions, is polymerized in the presence of an addition fragmentation chain transfer agent and a hydrophilic free radical initiator to form a seed polymer that is substantially insoluble in water and in which feed stage at least one ethylenically unsaturated feed monomer is added to the seed polymer to form polymer particles. With this method a polymer dispersion can be obtained having at least 25 wt. % solid contents in combination with an average polymer particle size smaller than or equal to 300 nm. The invention further relates to a polymer dispersion obtainable by a surfactant-free emulsion polymerization process, a film-forming composition, preferably a coating composition, comprising such a polymer dispersion and coated articles coated with the coating composition. Further, the invention relates to a polymer particle powder obtained from the polymer dispersion and powder coating compositions.

### CROSS REFERENCE TO RELATED APPLICATIONS

This application is a continuation of U.S. application Ser. No. 10/555,829 filed on Nov. 7, 2005, which is based on international application no. PCT/EP04/04800 filed on Apr. 29, 2004, which was published under PCT Article 21(2) in English, and which claims priority to EP application number 03076396.5 filed on 6 May 2003, the contents of all applications are hereby incorporated by reference in their entirety.

### FIELD OF INVENTION

The invention pertains a method to prepare a polymer dispersion using a surfactant-free emulsion polymerization process, a polymer dispersion obtainable by such method and the use of said polymer dispersion in various applications. The invention further pertains to a film-forming and a coating composition comprising said polymer dispersion and to coated articles coated with the coating composition. Further, the invention relates to a polymer particle powder obtained from the polymer dispersion and powder coating compositions.

### BACKGROUND OF INVENTION

Recent changes in the legislation concerning the emission of organic solvents have led to a growing interest in water borne coating systems for industrial applications. Water borne coating systems have already been in use for a long time in applications where the decorative aspects of the coating were more important than the protective properties. The aqueous polymer dispersions being used as binders in these coatings are often prepared by means of an emulsion polymerization process. A general description of the emulsion polymerization process is given in E.W. Duck, Encyclopedia of Polymer Science and Technology (John Wiley & Sons, Inc.: 1966), Vol. 5, pp. 801-859. A serious drawback to the conventional emulsion polymerization process is that in this process substantial amounts of surfactants must be used. The amounts used in general are above the critical micelle concentration for the surfactant used. Surfactants perform many functions in emulsion polymerization, including solubilizing hydrophobic monomers, determining the number and size of the dispersion particles formed, providing dispersion stability as particles grow, and providing dispersion stability during post-polymerization processing. Typical examples of surfactants used in emulsion polymerization are anionic surfactants like fatty acid soaps, alkyl carboxylates, alkyl sulfates, and alkyl sulfonates; nonionic surfactants like ethoxylated alkylphenol or fatty acids used to improve freeze—thaw and shear stability; and cationic surfactants like amines, nitriles, and other nitrogen bases, rarely used because of incompatibility problems. Often a combination of anionic surfactants or anionic and nonionic surfactants is used to provide improved stability. For example, US 2002/0072580 describes examples of a method for preparing a polymer dispersion using 1.5 to 6 wt. % surfactant in combination with Cobalt complexes or dimers as chain transfer agents to achieve small particle sizes.

The use of surfactants in emulsion polymerization leads to a number of problems when the resulting polymeric dispersions are being used in film-forming compositions such as coatings, printing inks, adhesives, and the like. Since conventional surfactants or emulsifiers are highly water-sensitive they impart poor water resistance to the films formed from the polymer dispersion containing them. Furthermore, conventional surfactants or emulsifiers often act as plasticizer for the polymers, resulting in reduced hardness of the resulting polymeric film. Another potential problem is the tendency of surfactant molecules to migrate to the polymer/air or polymer/substrate interface, often resulting in deleterious effects such as deteriorated esthetical properties like loss of gloss, cloudiness at the surface and/or loss of adhesion.

Recently a number of products have come onto the market which are known as “polymerizable surfactants”, where the molecule contains a polymerizable ethylenically unsaturated double bond. An example of the use of such a compound is given in WO 99/32522. The surfactant becomes bound to the main polymer during the emulsion polymerization. However, it is hard to obtain full conversion of these reactive surfactants. A comprehensive review of this subject is given by Asua et al. (Acta Polym., 49 (1998). 671). The non-converted polymerizable surfactant will behave in a way similar to that of conventional surfactants and hence will also negatively influence the application properties and the characteristics of the (film-forming) compositions comprising the polymer dispersions, as explained above.

The use of surfactants can be minimized or even avoided when water-soluble functional monomers like methacrylic acid, 2-hydroxyethyl acrylate, acrylamide, 2-dimethylaminoethyl methacrylate or sodium p-vinyl-benzene sulfonate that create in situ polymeric emulsifiers are used in the emulsion polymerization recipe. A drawback to this route is that the stability of the dispersion is strongly influenced by the pH.

Generally, the concentration of water-soluble functional monomer required for proper dispersion stability is rather high. Because the polymers derived from the monomers described above are also water-soluble, these high concentrations will negatively influence the water resistance properties of a film derived from the polymer dispersion. Furthermore, it is difficult to control the particle size and to reach solids contents that are high enough for industrial application of the resulting polymer dispersions.

Tauer et al. (Coll. Polym. Sci. 277 (1999), 607-626) describes a simple surfactant-free emulsion polymerization recipe with only three components: water, a hydrophobic monomer such as styrene, and an ionic initiator. Two different types of ionic initiators are described: potassium persulfate (KPS) and 2,2′-azobis(2-amidinopropane) dihydrochloride (V-50 from Wako® Chemicals). End groups on the polymer chains arising from free primary radicals formed by the decomposition of the ionic initiators used in this emulsion polymerization are claimed to be responsible for the particle nucleation and the colloidal stability of the final dispersion. The polymerization process described was also modified to include a water-soluble thiol based chain transfer agent (thiomalic acid). Thiomalic acid is claimed to lead to an enhanced formation of water-soluble surface-active oligomers and hence to have an effect on the final colloidal stability of the polymer dispersion. The polymer dispersions described have particle sizes in the range of 100 to 300 nm. However, in this method, achieving a low average particle size implies a low solids content in the dispersion. The solids contents that can be reached with the process described are only between 0.04 and 5 weight %, which makes this route unattractive from an industrial point of view, as polymer dispersions used as binders for coatings, adhesives, and printing inks should have a solids content of at least 10 wt. % and preferably higher. Furthermore, the thiol based chain transfer agents have the disadvantage of introducing sulfur atoms into the polymer chain. This may affect the durability of the polymer in the final application. Besides, the use of thiols always imparts an undesirable smell to the polymer dispersion.

US 2002/0049275 discloses a two-stage surfactant-free emulsion polymerization process wherein latex monomers are polymerized in the presence of a free radical initiator and a chain transfer agent. The chain transfer agents mentioned in this publication are both thiol- and chlorine-functional chain transfer agents. The polymerization process gives particles of a size of 50 to 1.000 nm. The polymers are used in the production of toner particles useful for imaging processes, especially xerographic processes. It is important to point out that the seed polymer in all these products contain from 1.5% up to 6% of a carboxylic acid-functional monomer. Incorporating high levels of acid functional monomers in a polymer dispersion can detract from the water-resistance in application of the polymer dispersion as a coating material. Further, the chlorine containing chain transfer agents used in US 2002/0049275 introduce Cl-terminal groups in the polymer chain. The presence of chlorine in the polymer is undesirable from an environmental point of view.

### BRIEF SUMMARY OF INVENTION

It is the object of the present invention to provide a method to prepare a polymer dispersion using a substantially surfactant-free emulsion polymerization process that allows for the synthesis of polymer dispersions with a very small average particle size and nevertheless a high solid content, and where the particle size distribution of the polymer particles can be controlled over a wide range. Particle sizes equal to or below 300 nm are preferred if the polymer dispersion is applied as main binder in the applications envisaged: coatings, printing inks, and adhesives because of the better stability and better film forming. Furthermore, the solids contents of dispersions made using the method of the invention can be varied over a wide range. For use as main binder in various industrial applications (e.g. coatings, printing inks, and adhesives) it is necessary that the polymer dispersion has a solids content of at least 10 wt. %.

A further object of the invention is to provide a polymer dispersion and polymer particles useful for the manufacture of a coating material that has improved water resistance and low extractable content.

According to the invention there is provided a method to prepare a polymer dispersion using an aqueous substantially surfactant-free emulsion polymerization process comprising a seed and a feed stage, in which seed stage at least one ethylenically unsaturated monomer, having a water-solubility of at least 0.3 g/l at polymerization conditions, is polymerized in the presence of an addition fragmentation chain transfer agent and a hydrophilic free radical initiator to form a seed polymer that is substantially insoluble in water and in which feed stage at least one ethylenically unsaturated feed monomer is added to the seed polymer to form polymer particles.

The inventors have found that with the method according to the invention it is possible to prepare a surfactant-free polymer dispersion wherein the average polymer particle size is smaller than or equal to 300 nm even in combination with high solid contents.

The obtained polymer dispersion is very suitable for use in coating compositions. The coating has a very good water resistance and a low extractable amount.

Furthermore, the method according to the invention can be performed without the addition of thiol- or chlorine-functional chain transfer agents. Also, in the method according to the invention it is not necessary that the resulting polymers contain from 1.5% up to 6% of a carboxylic acid-functional monomer. Another advantage is that the method according to the invention results in reduced formation of grit, being undesired coarse particles as is known in the art.

It is noted that in pending, non-published application PCT/EP02/12477 a two-stage surfactant-free emulsion polymerisation process is disclosed wherein in a seed stage, a mixture of ethylenically unsaturated monomers is polymerized, at least 70% of all ethylenically unsaturated bonds of these monomers being of a methacrylic nature, in the presence of one or more chain transfer agents of the formula

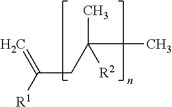

wherein R1 and, if present, each R2 are independently the same or different and selected from conventional radical stabilising groups, n is on average 0-10, to form a seed polymer with solvents, the monomers being selected such that the seed polymer is water-soluble or water-dispersible and subsequently, in a feed stage, a mixture comprising ethylenically unsaturated monomers is aqueous emulsion polymerized in the presence of the seed polymer to form a dispersion of water-insoluble polymer.

In the process according to the invention surfactant is not needed and in practice no surfactant will be added. However, if small amounts of surfactant would be added acceptable results could be obtained whilst still getting the benefits of the invention. Therefore, surfactant-free in the process of the invention means substantially surfactant-free, meaning less than 1 wt. % of surfactant, preferably less than 0.5 wt. %, more preferably less than 0.1 wt. %, even more preferably less than 0.05 wt. % and most preferably even less than 0.01 wt. % of surfactant.

Preferably in the method according to the invention the polymer particles have an average polymer particle size smaller than or equal to 300 nm, preferably in combination with a solids content of at least 10 wt. %, preferably 15 wt. %, more preferably 20 wt. %, even more preferred 22 wt. %, and most preferred at least 25 wt. %.

Preferably, the addition fragmentation chain transfer agent is a hydrophobic addition fragmentation chain transfer agent with a water solubility below 100 mg/l.

Preferably, in the method according to the invention, the amount of ethylenically unsaturated monomers of methacrylic nature in the seed stage is less than 70 wt. % of the total amount of monomers in this stage. Preferably, the amount is less than 50 wt. %, more preferably less than 30 wt. %. This is preferred in view of obtaining a more hydrophobic character, leading to better micelle forming properties after polymerisation.

With the term “of methacrylic nature” is meant methacrylic acid, methacrylate and methacrylate derivatives such as esters, amides, anhydrides.

In this application the term “addition fragmentation chain transfer agent” or “AF-CTA” refers to a chain transfer agent free of thiol or dithio or chlorine groups. The AF-CTA adds to a growing polymer chain and the resulting adduct fragments to form a stable polymer molecule with one pendant double bond and a new free radical that is able to initiate the polymerization of a new polymer molecule. (reference is made to Wanatabe et al, Chemistry letters, pp. 1089-1092 (1993). Preferably, AF-CTAs are hydrophobic AF-CTAs, meaning AF-CTAs having a solubility in water of below 100 mg/l, preferably 10 m g/l, more preferably 5 mg/l, even more preferably 1 mg/l, most preferably 0.5 mg/l. In this application, water solubility is the water solubility at room temperature calculated using the QSPR method (reference is made to C. Liang, D. Gallagher, American Laboratory March 1997). More preferably, by AF-CTA is meant a dimer, trimer or tetramer of alpha-methyl styrene, phenyl-substituted alpha-methyl styrene, methyl methacrylate, butyl methacrylate and/or hydroxyethyl methacrylate. Also cross-dimers, trimers, and tetramers or higher oligomers or co-oligomers are included in the term AF-CTA.

These AF-CTAs can be prepared as described by Yamada et al. (Journal of Polymer Science, Part A: Polymer Chemistry, Vol. 32, 2745-2754 (1994)). Even more preferably, the AF-CTA is a dimer, trimer or tetramer of alpha-methyl styrene. The most preferred AF-CTA is the commercially available alpha-methyl styrene dimer (“AMSD”). AMSD is preferred int. al. because besides being readily available, it is an “Existing” chemical substance (listed in the European INventory of Existing Commercial Substances), which has advantages from a registration point of view.

In JP-A-11292907 a surfactant-free emulsion polymerization system is described consisting of water, styrene or a styrene derivative, and a free radical initiator such as potassium persulfate. To the monomer 0.1 to 10 wt. % of alpha-methyl styrene dimer is added as chain transfer agent to control the molecular weight. The process leads to the formation of a mono-modal dispersion of polystyrene particles with average particle diameters in the range of 400-750 nm, such polymer dispersions being unsuitable for use in a film-forming composition such as a coating, printing ink or adhesive composition.

The emulsion polymerization process of this invention consists of two stages, a seed and a feed stage. In the seed stage a number of polymer particles are produced. These particles are then grown to their final diameter in the subsequent feed stage. The seed and feed stages can be performed separately or can be carried out one immediately after the other.

The seed stage is distinguished from the feed stage for example in that the monomer or monomer mixture in the seed and feed stage are added in separate portions or at least in distinguishable portions. Typically, the feed stage starts after a conversion of the seed monomers in the seed stage of at least 50 wt. %, preferably at least 60 wt. % or more preferably at least 80 wt. %. The seed and the feed stage may also be distinguished in that the composition of the monomers in the seed stage differ from the monomer in the feed stage and/or in that the temperature of reaction in the seed stage is different from the temperature at the feed stage. For example, the temperature of reaction in the seed stage may be chosen higher than the reaction temperature in the feed stage to achieve the required solubility of the seed monomers of at least 0.3 g/l. The seed polymer formed in the seed stage is substantially insoluble in water, that is at the prevailing reaction conditions. Preferably the seed polymer has a number average molecular weight between 750 and 15000.

Preferably, the polymerization process is performed in water that is essentially free of organic solvents. Essentially free of organic solvents means the water comprises less than 10 wt. %, preferably less than 5 wt. %, more preferably less than 1 wt. % and most preferably less than 0.01 wt. % of organic solvents.

The term (meth)acrylic monomer refers to both acrylic and methacrylic monomers. By (meth)acrylic is meant (meth)acrylate and (meth)acrylic acid.

### DETAILED DESCRIPTION

In the emulsion polymerization process of this invention the main ingredients used are water as the continuous phase, a monomer or a mixture of different monomers, an addition fragmentation chain transfer agent, and a hydrophilic free radical initiator. With hydrophilic free radical initiator is also meant a free radical initiation system that generates hydrophilic, ionic or ionizable polymer end groups.

Examples of Free Radical Initiators are:

Sodium or potassium persulphate that generates ionic sulphate radicals that can be used to obtain the ionizable polymer endgroups.

Wako VA-086 (Wako), (see figure), is an example of a non-ionic and water-soluble azo initiator and is useful in polymerizations when the presence of neutralizing agents is undesirable.

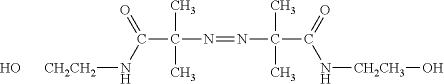

Another azo initiator that can lead to ionizable

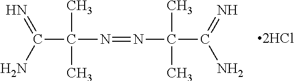

(Dupont), see figure.

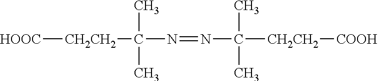

All of the monomers to be reacted in the feed stage can be added to the polymer dispersion from the seed stage at the start of that polymerization stage, or they can be added continuously or intermittently during the course of the polymerization stage. The polymerization process can alternatively be carried out in such a way that the amounts of monomers, relative to each other, are changed continuously. Free radical initiators can be introduced into the polymerization medium at the start of the polymerization, continuously or intermittently during the polymerization, or in some combination thereof. Free radical initiators can further be added at or near the end of the polymerization stage as a chaser to reduce the amount of unreacted residual monomer in the final polymer.

In a further preferred embodiment the at least one ethylenically unsaturated monomer comprises styrene or a derivative thereof. In a more preferred embodiment it comprises styrene with at least one (meth)acrylic monomer.

When monomers of drastically different solubility in water or hydrophobicity are used or when a staged monomer addition is used in the feed stage, the polymer particle may exhibit core-shell or gradient morphologies. The use of polymer dispersions with core-shell or gradient morphologies in order to obtain specific properties is well known to those skilled in the art.

### The Seed Stage

In the seed stage, water, a monomer or monomer mixture, the addition fragmentation chain transfer agent, and a hydrophilic free radical initiator system are reacted.

The seed stage polymerization of the monomer or monomer mixture is preferably carried out under atmospheric pressure at a temperature of 40-100° C., more preferably 60-90° C., in an atmosphere of an inert gas, such as nitrogen. If so desired, however, it is also possible to carry out the polymerization under elevated pressures at temperatures above 100° C.

The ratio of the monomer mixture to the AF-CTA in the seed stage is preferably from 80:20 to 99:1, more preferably from 90:10 to 99:1.

In a further preferred embodiment the AF-CTA is precharged to the seed stage. In a more preferred embodiment the AF-CTA is precharged and the seed monomers are subsequently dosed to the reaction mixture.

### The Monomer(s) in the Seed Stage

The ethylenically unsaturated monomers that can be used in the seed stage of the process of this invention are selected from the group consisting of monovinylidene aromatic monomers, alpha,beta-ethylenically unsaturated carboxylic acid monomers and derivatives thereof such as esters, vinyl ester monomers, and various combinations thereof.

The seed monomer or monomer mixture is advantageously composed of at least one monomer that has a solubility in water at the prevailing reaction conditions of at least 0.3 g/l, preferably 0.4 g/l, more preferably 0.5 g/l, even more preferably 0.7 g/l and most preferably at least 1 g/l. In case a monomer mixture is used, it is preferred that first the seed monomer is dosed that meets the above specified waste solubility criterium before other seed monomers are dosed.

Suitable monovinylidene aromatic monomers include styrene, alpha-methyl styrene, vinyl toluene, o-, m-, and p-methylstyrene, o-, m-, and p-ethylstyrene, and combinations thereof. Suitable alpha,beta-ethylenically unsaturated carboxylic acid ester monomers include the esters of (meth)acrylic acid, methyl methacrylate, ethyl methacrylate, butyl acrylate, and butyl methacrylate. A further suitable monomer is acrylonitrile.

Suitable vinyl ester monomers include vinyl acetate, vinyl propionate, vinyl butyrate, vinyl isobutyrate, and vinyl esters of versatic acid such as the monomers commercialized by Shell Chemicals under the trade names VEOVATM 9, 10, and 11), and combinations of these can be used.

The seed polymer preferably has a number average molecular weight Mn of between 750 and 15,000, more preferably between 1,000 and 10,000. The seed polymer formed is substantially insoluble in water at the polymerisation conditions. In view of that it is preferred that the seed polymer has an acid number less than 40, preferably less than 30, more preferably less than 20 and most preferably less than 10 mg KOH/(g. polymer). Preferably, the seed monomer mixture comprises less than 3, preferably less than 1.5, more preferably less than 1 and most preferably less than 0.5 wt. % ethylenically unsaturated carboxylic acid monomer. Evidently, the solubility of the seed polymer also depends on the nature of the other monomers in the monomer mixture. Following the teaching in this application the skilled man will be able to determine the appropriate composition of the monomer mixture.

### The Initiator(s) in the Seed Stage

The seed stage polymerization is generally carried out using a free radical initiator or free radical initiation system that generates non-ionic hydrophilic, ionic or ionizable polymer end groups. The seed stage polymerization is preferably an emulsion polymerization process.

Examples of initiators that generate ionically charged free radicals by homolytic decomposition are alkali or ammonium persulfate, 2,2′-azobis(2-amidinopropane)dihydrochloride (V-50 from Wake® Chemicals), 2,2′azobis[2-(2-imidazolin-2-yl)propane]dihydrochloride (VA-044 from Wake® Chemicals), 2,2′azobis[2-(2-imidazolin-2-yl)propane]disulfate dihydrate (VA-0468 from Wako® Chemicals), 2,2′-Azobis[2-(3,4,5,6-tetrahydropyrimidin-2-yl)propane]dihydrochloride (VA-058 from Wako® Chemicals). Alkali or ammonium persulfate can also be combined with a reducing agent. Suitable reducing agents which can be used in combination with a persulfate include iso-ascorbic acid, sodium formaldehyde sulfoxylate, thiosulfates, disulfates, and hydrosulfates. Optionally the redox initiating system (redox initiating system being the combination of initatior plus reducing agent) is used in the presence of reducing salts such as iron sulfate.

Other suitable initiators include azo initiators with a carboxylic acid group (derivative) such as 4,4′-azobis-(4-cyanovaleric acid) or 2,2′-azobis[N-(2-carboxyethyl)-2-methylpmpionamidine]tetrahydrate giving carboxylic acid-functional polymer end groups that can be ionized.

Further suitable initiators include macro azo initiators that generate a hydrophilic end group, such as described by Walz et al. (Makromol. Chem. 178, 2527 (1977)). Macro azo initiators include the initiators commercially available from Wako® Chemicals under the trade names VPE-0201, VPE-0401, and VPE-0601.

Further suitable examples of initiators are redox initiating systems where a substantially water-insoluble initiator is combined with a suitable reducing agent, which systems generate an ionic polymer end group. Suitable reducing agents which can be used in combination with a substantially water-insoluble peroxide or hydroperoxide include iso-ascorbic acid, sodium formaldehyde sulfoxylate, thiosulfates, disulfates, and hydrosul fates. Examples of substantially water-insoluble initators are bis(2-ethylhexyl) peroxydicarbonate, di-n-butyl peroxydicarbonate, t-butyl perpivalate, t-butyl hydroperoxide, cumene hydroperoxide, dibenzoyl peroxide, and dilauroyl peroxide. If desired, these redox initiating systems can be used in combination with reducing salts, such as iron sulfate.

Typically, initiators are used in an amount of from 0.5 to 5 wt. % of the total weight of the monomers. Preferably, in the method according to the invention the hydrophilic free radical initiator is present in an amount between 0.6 and 2.0 wt. %, more preferably between 0.6 and 1.4 wt. % and most preferably between 0.7 and 1.3 wt. %.

It is possible to use more than one initiator in the emulsion polymerization process.

### The Feed Stage

To the particles formed in the seed stage are added additional monomers, initiator, and optionally chain transfer agents to grow the seed particles to their final particle size and solids content.

The optional chain transfer agent in the feed stage can be of the addition fragmentation type as described for the seed stage. Also, conventional chain transfer agents (for example: n-octyl mercaptan, n-dodecyl mercaptan, butyl or methyl mercaptopropionate, mercaptopropionic acid, mercaptoethanol) can be used in the feed stage. However, this does detract from some of the benefits mentioned above.

Initiator systems that can be used in the feed stage include all free radical initiation systems that decompose by homolytic scission or chemically by redox reactions as explained above for the seed stage initiators.

### The Monomers in the Feed Stage

Monomers that can be used in the feed stage are monovinylidene aromatic monomers including styrene, alpha-methyl styrene, vinyl toluene, o-, m-, and p-methylstyrene, o-, m-, and p-ethylstyrene, alpha,beta-ethylenically unsaturated carboxylic acid monomers and derivatives thereof such as esters including methyl acrylate, ethyl acrylate, n-butyl acrylate, methyl methacrylate, butyl methacrylate, tertiary-butyl acrylate, 2-ethylhexyl acrylate, vinyl ester monomers such as vinyl acetate, vinyl propionate, vinyl butyrate, vinyl isobutyrate, vinyl esters of versatic acid such as the monomers commercialized by Shell Chemicals under the trade names VEOVATM 9, 10, and 11), acrylonitrile, and combinations of all the above.

Monomers that have an additional functional group may be used as part of the feed monomer composition. Non-limiting examples of such monomers are (meth)acrylic monomers and derivatives thereof having a hydroxy group such as hydroxyethyl methacrylate, hydroxyethyl acrylate, hydroxypropyl acrylate, hydroxypropyl methacrylate, hydroxybutyl acrylate. Also monomers having latent hydroxy groups such as glycidyl methacrylate can be used. Other functional monomers are ketone-functional monomers such as the acetoacetoxy esters of hydroxyalkyl acrylic monomers and methacrylic monomers such as acetoacetoxyethyl methacrylate, and also keto-containing amides such as diacetone acrylamide.

It is preferred to use monomers containing an additional functional group wherein the functional group imparts certain properties to the polymer dispersion, such as stability, or to the film-forming composition formulated with the polymer dispersion, such as adhesion, cross-linking, etc. Such additional functional groups are well known to the person skilled in the art, but some typical examples are given below.

The stability of the polymer dispersion can be further improved by the use of (co)monomers with a hydrophilic group such as an acid or amide group. Typical acid-group containing monomers are olefinically unsaturated carboxyl-functional monomers and derivative thereof such as anhydrides, such as monocarboxyl-functional acrylic monomers and ethylenically unsaturated dicarboxyl bearing monomers; examples include acrylic acid, methacrylic acid, maleic acid, fumaric acid, citraconic acid and itaconic acid. Sulfonic acid-group containing monomers can also be used, such as styrene p-sulfonic acid, ethylmethacrylate-2-sulfonic acid or 2-acrylamido-2-methyl-1-propane sulfonic acid. Phosphate ester monomers can also be used such as 2-hydroxyethyl acrylate phosphate or 2-hydroxyethyl methacrylate phosphate. Also the phosphate ester of ethoxylated or propoxylated hydroxy-functional acrylic or methacrylic monomers can be used. An acid bearing monomer can be polymerized as the free acid or as a salt, e.g. the NH4 or alkali metal salts. Amide-functional co-monomers include acrylamide and methacrylamide. After the polymerizaton process, the acid functional groups, if present, are preferably neutralised with a base.

Examples of functional monomers that can be included to improve the adhesion of coatings containing the polymer dispersion comprise tertiary amino or ethylene ureido-functional monomers such as dimethylamino ethyl methacrylate and N-(2-methacryloyloxethyl)ethylene urea monomers.

Minor amounts of monomers having more than one ethylenically unsaturated bond can be used in the feed monomer composition. Useful multi-ethylenically unsaturated monomers include allyl (meth)acrylate, diallyl phthalate, triallyl cyanurate, 1,4-butylene glycol di(meth)acrylate. 1,6-hexanediol di(meth)acrylate, and 1,1,1-trimethylolpropane tri(meth)acrylate.

Conventional additives can be used in either the seed and/or the feed stage. Although less preferred, they include monomers with surfactant-like properties, radical scavengers, including nitroxides, pigments, plasticizers, stabilizers, and the like.

In a preferred embodiment the weight of the seed polymer is between 60 and 5 wt. % of the weight of the polymer resulting after completion of the feed stage.

### Polymer Dispersions and the Use Thereof

The invention also relates to a polymer dispersion obtainable by an emulsion polymerization method according to the invention and, in particular, to a polymer dispersion comprising less than 1 wt. %, preferably less than 0.05 wt. % surfactant, wherein the polymer particles have an average particle size smaller than or equal to 300 nm and wherein the dispersion has a solids content of at least 25 wt. %. This polymer dispersion has outstanding properties in a use according to the invention of said polymer dispersion for the manufacture of a coating composition, a film forming composition, a printing ink, a toner composition, a powder coating composition, optical dispersing agents or adhesives.

The polymer dispersions of the invention are particularly suitable for use in different types of film-forming compositions, such as coating compositions (e.g. protective, decorative or adhesive) or printing inks. The invention hence also relates to film-forming composition, preferably a coating composition comprising a polymer dispersion according to the invention and further film forming additives and top coated articles wherein the article is coated with said film-forming composition or coating composition.

Before use of the polymer dispersion in, for example, a film-forming composition, it may be advantageous to process the polymer dispersion, for example, to lower the water content thereof, to isolate the polymer from the dispersion and/or to purify the dispersion or the polymer isolated therefrom. A suitable method to further process the polymer dispersion includes spray-drying the dispersion and isolating the polymer in powder form (which powder may be re-dispersed if necessary).

The invention also relates to a polymer particle powder that is substantially surfactant free, obtainable by separating the polymer particles from the polymer dispersion according to the invention. The powder can be used on itself or as component in various different applications, for example in a printing ink, a toner composition, a powder coating composition, as optical dispersing agents for example in projector screens or in adhesives. The invention further relates to a powder, in particular acrylic polymer powder, coating composition comprising a polymer particle powder according to the invention.

Depending on the application, cross-linkers can be added to the film-forming composition.

In order for the polymer dispersion to have a sufficient cross-linking capacity, it is preferred that one or more of the monomers used comprise cross-linkable groups. Preferably, such cross-linkable groups are selected from: hydroxyl groups, acid groups, aldehyde or carbonyl groups, amine groups and oxirane groups. More preferably, these functional groups are derived from esters or amides of methacrylic acid. It is possible to use more than one kind of monomer with cross-linkable groups.

For film-forming compositions comprising the present polymer composition it is preferred to introduce cross-links during the drying step. To achieve this, it is preferred to use a cross-linking agent which reacts with the preferred cross-link functional groups of the polymer, which were incorporated in the process according to the invention. The cross-linking agent can be added to the polymer dispersion after the emulsion polymerization, if the choice is made to react it with the cross-link functional groups of the polymer upon drying of the film-forming composition (e.g. due to the evaporation of the water in the formulation). In this way attractive 1K ambient temperature curing systems can be produced. However, the cross-linking agent can also be added to the film-forming composition, at a later stage, e.g. during the formulation of the final film-forming composition. In a preferred embodiment the cross-linking agent is added just prior to the application of the film-forming composition to the substrate (two component coating) is.

The selection of the cross-linking compound that is added to the polymer dispersion and that can react with the functional group of the polymer depends on the chemical nature of this group. This compound can be either a polymeric or a low-molecular weight compound. In order to effect cross-linking, the cross-linking compound must possess at least two co-reactive groups. Examples of suitable co-reactive groups for given pendant functional groups are known to those skilled in the art. Non-limiting examples are given in Table A.

TABLE A

| Reactive group | Co-reactive groups |
|---|---|
| Amine | oxirane, isocyanate, ketone, aldehyde, |
| | acetoacetoxy |
| Hydroxy | Methylol, etherified methylol, |
| | isocyanate, aldehyde |
| Ketone, including acetoacetoxy | Amino, hydrazide, aldehyde |
| Aldehyde | Amino, hydrazide |
| Urea | Glyoxal |
| Oxirane | Carboxylic acid, amino, thiol |

Cross-linking of the film-forming composition can be carried out at ambient temperature or at elevated temperatures of about 60-180° C. for about 5-60 minutes. The selection of the polymer composition and the cross-linker to be used in one- or two-pack formulations is known to those skilled in the art.

The polymer dispersions from this invention can be utilized to produce coatings, adhesives or printing inks by blending with other suitable components in accordance with normal formulation techniques. For such purposes the dispersions can be combined or formulated with other additives or components, such as additional polymers, defoamers, rheology control agents, thickeners, dispersing and stabilizing agents (usually surfactants), wetting agents, fillers, extenders, fungicides, bactericides, coalescing solvents, wetting solvents, plasticizers, anti-freeze agents, waxes, and pigments.

Film-forming compositions comprising a polymer dispersion according to the present invention can be applied to various substrates, such as metal, wood, paper, cardboard, gypsum, concrete, plastic, etc. Various known application methods may be used, such as brushing, spraying, rolling, dipping, printing, etc.

Preferably, the polymer dispersions of the present invention are used as film-forming vehicles in the preparation of water borne coating compositions, for example, clear coat or base coat compositions useful in automotive, OEM and refinish, applications. In particular, a polymer dispersion according to the present invention can be used in clear or pigmented coating compositions.

The invention is further illustrated by the following examples.

Specification of methods: The average polymer particle size was determined by measuring the particle size distribution using a Coulter Counter LS® laser diffraction apparatus.

### Example 1

A polymer dispersion having the composition of Table I is prepared as described in Table II.

TABLE I
Emulsion polymerization scheme (amounts in g).

| Mixture | compound | g |
|---|---|---|
| A | NaHCO3 | 0.1 |
| | Demineralized water | 58.3 |
| B | Demineralized water | 263.5 |
| C | Styrene | 23.64 |
| | α-Methylstyrene dimer (AMSD) | 2 |
| D | Potassium persulfate | 0.24 |
| | Demineralized water | 6 |
| E | Demineralized water | 3 |
| F | Styrene | 133 |
| G | Potassium persulfate | 1.34 |
| | Demineralized water | 40 |

TABLE II
Preparation scheme:
Preparation procedure:

| | |
|---|---|
| 1. | Homogenize each of the mixtures of [A], [C], [D], [G] |
| 2. | Load the reactor (four-necked round-bottom flask) with [B] and 10 g |
| | of [A] |
| 3. | Apply 3 vacuum/nitrogen flushes at RT |
| 4. | Heat the contents of the reactor to 90° C. under a nitrogen blanket. |
| 5. | Subsequently add the mixtures according the following scheme, |
| | keeping the temperature at 90° C.: |
| | a. 3.15 g of [C] |
| | b. 4.91 g of [D] |
| | c. [E] |
| | React for 30 minutes, under stirring at 500 rpm |
| 6. | Feed [F] and [G] over a period of 6 hours, keeping the temperature |
| | at 90° C. |
| 7. | Maintain the temperature at 90° C. for an additional 20 minutes |
| 8. | Cool the reaction mixture to room temperature, and filter. |

A sample taken after step 5 had a particle size of 96 nm. The finally resulting fine polymer dispersion had a solids contents of 30.4% and was completely free of low-molecular weight surfactant and organic solvents. The average particle size was determined and was found to be 309 nm. A sample taken before completion of step 6, when 84% of the styrene of feed [F] had been added, showed an average particle size of 279 nm at a solids content of 25%. Some minor grit formation occurred in the reactor during the process.

### Example 2

A polymer dispersion having the composition of Table III is prepared as described in Table IV.

TABLE III
Emulsion polymerization scheme (amounts in g).

| Mixture | Compound | g |
|---|---|---|
| A | NaHCO3 | 0.1 |
| | Demineralized water | 58.3 |
| B | Demineralized water | 263.5 |
| C | Methyl methacrylate | 23.64 |
| | α-Methylstyrene dimer (AMSD) | 2 |
| D | Potassium persulfate | 0.24 |
| | Demineralized water | 6 |
| E | Demineralized water | 3 |
| F | Styrene | 133 |
| G | Potassium persulfate | 1.34 |
| | Demineralized water | 40 |

TABLE IV
Preparation scheme:
Preparation procedure:

| | |
|---|---|
| 1. | Homogenize each of the mixtures of [A], [C], [D], [G] |
| 2. | Load the reactor with [B] and 10 g of [A] |
| 3. | Apply 3 vacuum/nitrogen flushes at RT |
| 4. | Heat the contents of the reactor to 90° C. under a nitrogen blanket. |
| 5. | Subsequently add the mixtures according to the following scheme, |
| | keeping the temperature at 90° C.: |
| | a. 3.15 g of [C] |
| | b. 4.91 g of [D] |
| | c. [E] |
| | React for 30 minutes, under stirring at 500 rpm |
| 6. | Feed [F] and [G] over a period of 6 hours, keeping the temperature |
| | at 90° C. |
| 7. | Maintain the temperature at 90° C. for an additional 20 minutes |
| 8. | Cool the reaction mixture to room temperature, and filter. |

A sample taken after step 5 had a particle size of less than 90 nm. The finally resulting fine polymer dispersion had a solids contents of 30.7% and was completely free of low-molecular weight surfactant and organic solvents. The average particle size was determined and was found to be 295 nm. No significant grit formation occurred during the process.

### Comparative Example 1

A polymer dispersion having the composition of Table V is prepared as described in Table VI.

TABLE V
Emulsion polymerization scheme (amounts in g).

| Mixture | Compound | g |
|---|---|---|
| A | NaHCO3 | 0.1 |
| | Demineralized water | 58.3 |
| B | Demineralized water | 263.5 |
| C | Styrene | 3.15 |
| D | Potassium persulfate | 0.24 |
| | Demineralized water | 6 |
| E | Demineralized water | 3 |
| F | Styrene | 133 |
| G | Potassium persulfate | 1.34 |
| | Demineralized water | 40 |

TABLE VI
Preparation scheme:
Preparation procedure:

| | |
|---|---|
| 1. | Homogenize each of the mixtures of [A], [C], [D], [G] |
| 2. | Load the reactor with [B] and 10 g of [A] |
| 3. | Apply 3 vacuum/nitrogen flushes at RT |
| 4. | Heat the contents of the reactor to 90° C. under a nitrogen blanket. |
| 5. | Subsequently add the mixtures according to the following scheme, |
| | keeping the temperature at 90° C.: |
| | a. 3.15 g of [C] |
| | b. 4.91 g of [D] |
| | c. [E] |
| | React for 30 minutes, under stirring at 500 rpm |
| 6. | Feed [F] and [G] over a period of 6 hours, keeping the temperature |
| | at 90° C. |
| 7. | Maintain the temperature at 90° C. for an additional 20 minutes |
| 8. | Cool the reaction mixture to room temperature, and filter. |

A sample taken after step 5 had a particle size of 136 nm. Another sample, taken after one third of step 6 was completed, already showed a bimodal particle size distribution with a peak of 417 nm, next to one at below 150 nm. The finally resulting polymer dispersion had a solids contents of 30.4%. The particle size after completion of the process was measured and gave an average value of 633 nm. Grit formation was observed in the reactor.

### Example 3

A polymer dispersion having the composition of Table VII is prepared as described in Table VIII.

TABLE VII
Emulsion polymerization scheme (amounts in g).

| Mixture | Compound | g |
|---|---|---|
| A | NaHCO3 | 0.1 |
| | Demineralized water | 58.3 |
| B | Demineralized water | 263.5 |
| C | Methyl methacrylate | 23.64 |
| | α-Methylstyrene dimer (AMSD) | 2.01 |
| D | Potassium persulfate | 0.24 |
| | Demineralized water | 6 |
| E | Demineralized water | 3 |
| F | Methyl methacrylate | 133 |
| G | Potassium persulfate | 1.33 |
| | Demineralized water | 40 |

TABLE VIII
Preparation scheme:
Preparation procedure:

| | |
|---|---|
| 1. | Homogenize each of the mixtures of [A], [C], [D], [G] |
| 2. | Load the reactor with [B] and 10 g of [A] |
| 3. | Apply 3 vacuum/nitrogen flushes at RT |
| 4. | Heat the contents of the reactor to 90° C. under a nitrogen blanket. |
| 5. | Subsequently add the mixtures according to the following scheme, |
| | keeping the temperature at 90° C.: |
| | a. 3.15 g of [C] |
| | b. 4.91 g of [D] |
| | c. [E] |
| | React for 30 minutes, under stirring at 500 rpm |
| 6. | Feed [F] and [G] over a period of 4 hours, keeping the temperature |
| | at 90° C. |
| 7. | Maintain the temperature at 90° C. for an additional 20 minutes |
| 8. | Cool the reaction mixture to room temperature, and filter. |

The finally resulting fine polymer dispersion had a solids contents of 30.1% and was completely free of low-molecular weight surfactant and organic solvents. The average particle size was measured and was found to be 219 nm. Some grit formation occurred in the reactor during the process.

### Comparative Example 2

A polymer dispersion having the composition of Table IX is prepared as described in Table X.

TABLE IX
Emulsion polymerization scheme (amounts in g).

| Mixture | Compound | g |
|---|---|---|
| A | NaHCO3 | 0.1 |
| | Demineralized water | 58.3 |
| B | Demineralized water | 263.5 |
| C | Methyl methacrylate | 3.15 |
| D | Potassium persulfate | 0.24 |
| | Demineralized water | 6 |
| E | Demineralized water | 3 |
| F | Methyl methacrylate | 133 |
| G | Potassium persulfate | 1.34 |
| | Demineralized water | 40 |

TABLE X
Preparation scheme:
Preparation procedure:

| | |
|---|---|
| 1. | Homogenize each of the mixtures of [A], [C], [D], [G] |
| 2. | Load the reactor with [B] and 10 g of [A] |
| 3. | Apply 3 vacuum/nitrogen flushes at RT |
| 4. | Heat the contents of the reactor to 90° C. under a nitrogen blanket. |
| 5. | Subsequently add the mixtures according to the following scheme, |
| | keeping the temperature at 90° C.: |
| | a. 3.15 g of [C] |
| | b. 4.91 g of [D] |
| | c. [E] |
| | React for 30 minutes, under stirring at 500 rpm |
| 6. | Feed [F] and [G] over a period of 4 hours, keeping the temperature |
| | at 90° C. |
| 7. | Maintain the temperature at 90° C. for an additional 20 minutes |
| 8. | Cool the reaction mixture to room temperature, and filter. |

The finally resulting polymer dispersion had a solids contents of 28.6%. The average particle size was determined and was found to be 437 nm. Grit formation occurred in the reactor during the process.

In the examples it is clearly demonstrated that the use of the method according to the invention results in a polymer dispersion with an average polymer particle size smaller than or equal to 300 nm and a reduced formation of grit.

### Comparative Example 3

A polymer dispersion having the composition of Table XI is prepared as described in Table XII.

TABLE XI
Emulsion polymerization scheme (amounts in g).

| Mixture | compound | g |
|---|---|---|
| A | NaHCO3 | 0.1 |
| | Demineralized water | 58.3 |
| B | Demineralized water | 263.5 |
| C | Methyl methacrylate | 23.64 |
| | dodecylmercaptane | 2 |
| D | Potassium persulfate | 0.24 |
| | Demineralized water | 6 |
| E | Demineralized water | 3 |
| F | Methyl methacrylate | 133 |
| G | Potassium persulfate | 1.34 |
| | Demineralized water | 40 |

TABLE XII
Preparation scheme:
Preparation procedure:

| | |
|---|---|
| 1. | Homogenize each of the mixtures of [A], [C], [D], [G] |
| 2. | Load the reactor with [B] and 10 g of [A] |
| 3. | Apply 3 vacuum/nitrogen flushes at RT |
| 4. | Heat the contents of the reactor to 90° C. under a nitrogen blanket. |
| 5. | Subsequently add the mixtures according to the following scheme, |
| | keeping the temperature at 90° C.: |
| | a. 3.15 g of [C] |
| | b. 4.91 g of [D] |
| | c. [E] |
| | React for 30 minutes, under stirring at 500 rpm |
| 6. | Feed [F] and [G] over a period of 3 hrs and 30 minutes, keeping the |
| | temperature at 90° C. |
| 7. | Maintain the temperature at 90° C. for an additional 20 minutes |
| 8. | Cool the reaction mixture to room temperature, and filter. |

The finally resulting fine polymer dispersion had a solids contents of 30.1%.

The average particle size was determined and was found to be 406 nm. Grit formation occurred in the reactor during the process.

1. A method to prepare a polymer dispersion using an aqueous substantially surfactant-free emulsion polymerization process comprising a seed and a feed stage, in which seed stage at least one ethylenically unsaturated monomer, having a water-solubility of at least 0.3 g/l at polymerization conditions, is polymerized in the presence of an addition fragmentation chain transfer agent, wherein the addition fragmentation chain transfer agent is selected from the group consisting of: dimers, trimers or tetramers of alpha-methyl styrene, phenyl-substituted alpha-methyl styrene, methyl methacrylate, butyl methacrylate and hydroxyethyl methacrylate and a hydrophilic free radical initiator to form a seed polymer that is substantially insoluble in water, wherein when a seed monomer mixture is used the monomer mixture comprises less than 1.5 wt % ethylenically unsaturated carboxylic acid monomer, and in which feed stage at least one ethylenically unsaturated feed monomer is added to the seed polymer to form polymer particles.

2. The method according to claim 1 wherein the polymer particles have an average particle size smaller than or equal to 300 nm.

3. The method according to claim 1, wherein the polymer dispersion has a solids content of at least 10 wt. %.

4. The method according to claim 1 wherein the polymer particles have an average particle size smaller than or equal to 300 nm and wherein the dispersion has a solids content of at least 25 wt. %.

5. The method according to claim 1, wherein the seed polymer has a number average molecular weight of between 750 and 15000.

6. The method according to claim 1, wherein the addition fragmentation chain transfer agent is pre-charged.

7. The method according to claim 1, wherein the addition fragmentation chain transfer agent is a hydrophobic addition fragmentation chain transfer agent with a water solubility of below 100 mg/l.

8. The method according to claim 1, wherein the at least one ethylenically unsaturated seed and/or feed monomers comprise styrene.

9. The method according to claim 1, wherein the seed monomer is styrene and the temperature of polymerization in the seed stage is at least 40° C.

10. The method according to claim 1, wherein the polymerization process is performed in water that is essentially free of organic solvents.

11. The method according to claim 1, wherein the hydrophilic free radical initiator is present in an amount between 0.6 and 2.0 wt. %.

12. The method according to claim 1, wherein the feed monomers comprise monomers with an additional functional group.

13. A polymer dispersion obtainable by an emulsion polymerization method according to claim 1.

14. A polymer dispersion according to claim 13, comprising less than 1 wt % surfactant, wherein the polymer particles have an average particle size smaller than or equal to 300 nm and wherein the dispersion has a solids content of at least 25 wt. %.

15. The polymer dispersion according to claim 13, wherein the dispersed polymer is a styrenic and/or acrylic polymer or copolymer, optionally comprising functional groups.

16. A coating composition, a film forming composition, a printing ink, a toner composition, a powder coating composition, optical dispersing agents, or adhesives comprising the polymer dispersion according to claim 13.

17. A film-forming composition comprising the polymer dispersion according to claim 13 and at least one film forming additive.

18. Coated articles wherein the article is coated with a film-forming composition or coating composition according to claim 17.

19. A polymer particle powder that is substantially surfactant free, obtainable by separating the polymer particles from the polymer dispersion according to claim 13.

20. A powder coating composition comprising a polymer particle powder according to claim 19.
